(19) United States
(12) Patent Application Publication
(10) Pub. No.: US 2003/0204438 A1
(43) Pub. Date: Oct. 30, 2003

(54) Method for acquisition and distribution of behavioral data for content performance evaluation

(75) Inventors: William G. Connelly, Vista, CA (US); Mary A. Spio, Long Beach, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/424,252

(22) Filed: Apr. 28, 2003

Related U.S. Application Data
(60) Provisional application No. 60/376,086, filed on Apr. 29, 2002.

(51) Int. Cl. G06F 17/60

(52) U.S. Cl. 705/10

(57) ABSTRACT

The invention discloses a method and system for acquiring behavioral data for content evaluation. One or more survey questions are provided to members of an audience for a exhibitor system and responses to the one or more survey questions are accumulated from the members of the audience at a central database received through the exhibitor system. The responses to the survey questions identify behavioral parameters of the audience.

### CROSS-REFERENCE TO RELATED APPLICATIONS

This application claims the benefit under 35 U.S.C. §119(e) of the following co-pending and commonly-assigned U.S. patent application, which is incorporated by reference herein:

U.S. Provisional Patent Application No. 06/376,0086, filed Apr. 29, 2002, by William G. Connelly et al., and entitled “METHOD FOR ACQUISITION AND DISTRIBUTION OF BEHAVIORAL DATA FOR CONTENT PERFORMANCE EVALUATION”.

This application is related to the following co-pending and commonly-assigned U.S. patent applications, which are both incorporated by reference herein:

U.S. Provisional Application Ser. No. 60/376,105, filed Apr. 29, 2002, by Charles F. Stirling, Bernard M. Gudaitis, William G. Connelly and Catherine C. Girardey, entitled “SECURE DATA CONTENT DELIVERY SYSTEM FOR MULTIMEDIA APPLICATIONS UTILIZING BANDWIDTH EFFICIENT MODULATION”; and

U.S. Provisional Application Ser. No. 60/376,244, filed Apr. 29, 2002, by Ismael Rodriguez and James C. Campanella, entitled “A METHOD TO SECURELY DISTRIBUTE LARGE DIGITAL VIDEO/DATA FILES WITH OPTIMUM SECURITY”.

### BACKGROUND OF THE INVENTION

1. Field of the Invention

The present invention relates to systems and methods for acquiring and distributing audience behavioral data. Particularly, this invention relates to the acquisition and distribution of such data in conjunction with a digital cinema system.

2. Description of the Related Art

According to the Motion Picture Association of America (MPAA), the cost of launching a new movie in the U.S. is $82 million approximately $52 million for production costs and $30 million for marketing and distribution. Presently solutions for gathering audience behavioral data are fragmented and inefficient. There is no efficient mechanism for gathering this data from multiple sources and directing it to a central location. Hence, available processes are inadequate for widespread industry use. The enormously high investment risks associated with producing, marketing and distributing an intangible product such as movies necessitate a centralized and efficient mechanism for decision-makers before, during and after movie releases. Currently once a movie is released, there is no centralized way to determine widespread audience opinion.

Currently over 60% of all movies released are considered to be unsuccessful based on the performance of movies domestically and internationally. The determining factor of performance of movies is based on ticket sales, which is solely impacted by a subjective and intangible factor, audience acceptance of the movie. A mechanism for collecting data on this subjective and intangible factor is a real challenge for the movie industry. With the high investment risks associated with producing, marketing and distributing a movie, there is an urgent need for a centralized mechanism to gather audience behavioral parameters.

In addition, the movie venue provides a good source for opinion polling on other products services as well if an efficient system existed to obtain the opinions of audience members.

In view of the foregoing, the present invention provides a system and method for surveying cinema audience members and directing their responses to a central source. In addition, the present invention can be integrated into a digital cinema system which delivers movie content to multiple theaters from a distributing entity. These and other advantages of the present invention are detailed hereafter.

### SUMMARY OF THE INVENTION

This invention presents a system and method for acquiring and distributing audience behavioral data used in the performance evaluation of motion pictures. The invention is particularly useful and adapted for implementation in the context of a centralized digital cinema system.

This novel method provides a mechanism for collecting and distributing audience behavioral data to content generators and associated industry decisionmakers. This data will help them to make better decisions regarding advertising, production and distribution of content for mass consumption.

Audiences can use a wireless input device such as a personal cell phone or other device to interface or fill out a questionnaire with general items related to their movie experience, based on different sets of information stimuli and post-movie evaluations. Data will then be collected from various information sources and transported via satellite, fiber or any other available means to a central location for storage and distribution to interested agents.

The invention provides a system for acquiring behavioral data for content evaluation. A typical embodiment includes a device for providing one or more survey questions to members of an audience of a exhibitor system of a cinema system and a central database for accumulating responses to the one or more survey questions from the members of the audience received through the cinema system. The responses to the survey questions identify behavioral parameters of the audience that can be distributed to various advertisers and content providers to apply in marketing, product and content development. The questions can relate to a movie or advertisement viewed by the audience on the exhibitor system.

A cinema system, such as a cinema system which broadcasts movies from a central source, is a key element of the present invention. Questions and responses to and from the audience can be easily communicated through the infrastructure established by the cinema system. For example, the received responses can be communicated to the central database through a back channel from the exhibitor system. The questions to the audience can be provided on a display (e.g. the cinema screen) of the exhibitor system.

In some embodiments of the invention, the responses to the questions can be received through a wireless device. For example, the wireless device can comprise a cellular phone or a personal digital assistant (PDA). The wireless device can also comprise a wireless network device. As an alternative to displaying the questions on a display of the exhibitor system, the wireless device can be used to provide the questions to the members of the audience.

The central source can receive the responses to the one or more survey questions directly from the at least one wireless device. e.g., if a cellular phone or other commercial wireless service is used. For example, in one particular embodiment, the wireless device can provide the one or more survey questions through a short messaging service. In another embodiment, a receiver disposed at the exhibitor system can receive the question responses from the wireless device and communicate them through the exhibitor system to the central source.

### BRIEF DESCRIPTION OF THE DRAWINGS

Referring now to the drawings in which like reference numbers represent corresponding parts throughout:

FIGS. 1A & 1B depict a top-level functional block diagram of one embodiment of a typical media program distribution system;

FIG. 2 is a functional block diagram of a computer system that can be used to perform the operations of the media preparation processor;

FIG. 3 is a block diagram of an exhibitor system of the present invention including the audience survey system;

FIG. 4 is a block diagram of a central source for accumulating the responses from the audience survey system; and

FIG. 5 is a flowchart of a typical method of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1. Digital Cinema System

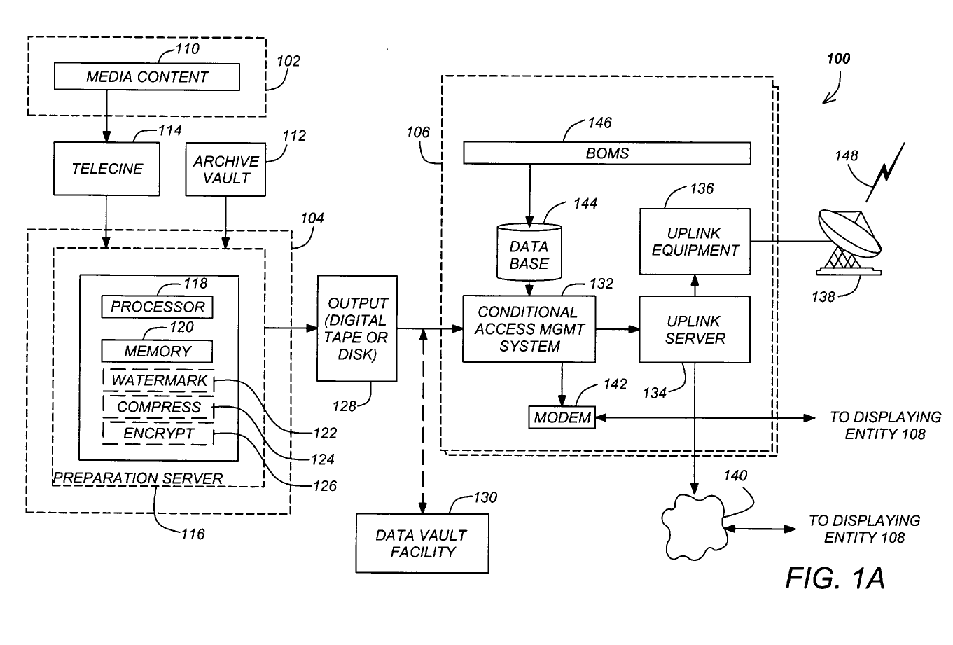

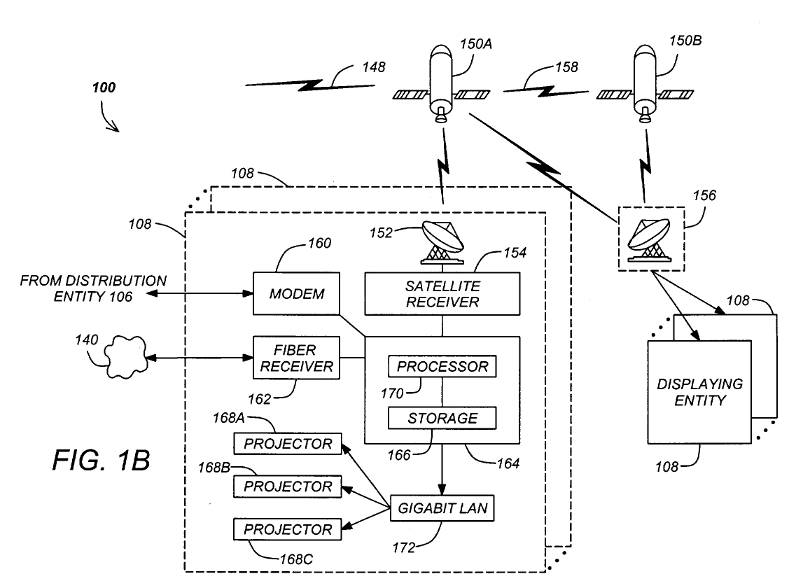

FIGS. 1A and 1B depict a top-level functional block diagram of one embodiment of a media program distribution system 100. The media distribution system 100 comprises a content provider 102, a protection entity 104, a distribution entity 106 and one or more presentation/displaying entities 108. The content provider 102 provides media content 110 such as audiovisual material to the protection entity 104. The media content 110, which can be in digital or analog form, can be transmitted in electronic form via the Internet, by dedicated land line, broadcast, or by physical delivery of a physical embodiment of the media (e.g. a celluloid film strip, optical or magnetic disk/tape). Content can also be provided to the protection entity 104 (also referred to as a preparation entity) from a secure archive facility 112.

The media content 110 may be telecined by processor 114 to format the media program as desired. The telecine process can take place at the content provider 102, the protection entity 104, or a third party.

The protection entity 104 may include a media preparation processor 116. In one embodiment, the media preparation processor 116 includes a computer system such as a server, having a processor 118 and a memory 120 communicatively coupled thereto. The protection entity 104 further prepares the media content 110. Such preparation may include adding protection to the media content 110 to prevent piracy of the media content 110. For example, the preparation processor 116 can add watermarking 122 and/or encrypt 126 the media content 110 to protect it. In addition, the preparation processor can also apply compression 124 to the media content 110. Once prepared, the output media content 128 can be transferred to digital tape or a disk (e.g. a DVD, laserdisk, or similar medium). The output media content 128 can then be archived in a data vault facility 130 until it is needed.

When needed, the prepared output media content 128 is then provided to the distribution entity 106 (alternatively referred to hereinafter as the network operations center [NOC]). Although illustrated as separate entities, the protection entity 104 and the distribution entity 106 can be combined into a single entity, thus ameliorating some security concerns regarding the transmission of the output media content 128.

The distribution entity 106 includes a conditional access management system (CAMS) 132 (also referred to as a configuration management engine), that accepts the output media content 128, and determines whether access permissions are appropriate for the content 128. Further, CAMS 132 may be responsible for additional encrypting so that unauthorized access during transmission is prevented. Once the data is in the appropriate format and access permissions have been validated, CAMS 132 provides the output media content 128 to an uplink server 134, ultimately for transmission by uplink equipment 136 to one or more displaying entities 108 (also referred to as exhibitor systems) (shown in FIG. 1B). This is accomplished by the uplink equipment 136 and uplink antenna 138. Also, as shown, in addition or in the alternative to transmission via satellite, the media program can be provided to the displaying entity 108 via a forward channel fiber network 140. Additionally, information may be transmitted to displaying entity 108 via a modem 142 using, for example a public switched telephone network line. A land based communication such as through fiber network 140 or modem 142 (e.g., through DSL internet or PSTN) is referred to as a back channel. Thus, information can be transmitted to and from the displaying entity 108 via the back channel or the satellite network. Typically, the back channel provides data communication for administration functions (e.g. billing, authorization, usage tracking, etc.), while the satellite network provides for transfer of the output media content 128 to the displaying entities 108.

The output media content 128 may be securely stored in a database 144. Data is transferred to and from the database 144 under the control and management of the business operations management system (BOMS) 146. Thus, the BOMS 146 manages the transmission of information to 108, and assures that unauthorized transmissions do not take place.

Turning to FIG. 1B, the data transmitted via uplink 148 is received in a satellite 150A, and transmitted to a downlink antenna 152, which is communicatively coupled to a satellite or downlink receiver 154.

In one embodiment, the satellite 150A also transmits the data to an alternate distribution entity 156 and/or to another satellite 150B via crosslink 158. Typically, satellite 150B services a different terrestrial region than satellite 150A, and transmits data to displaying entities 108 in other geographical locations.

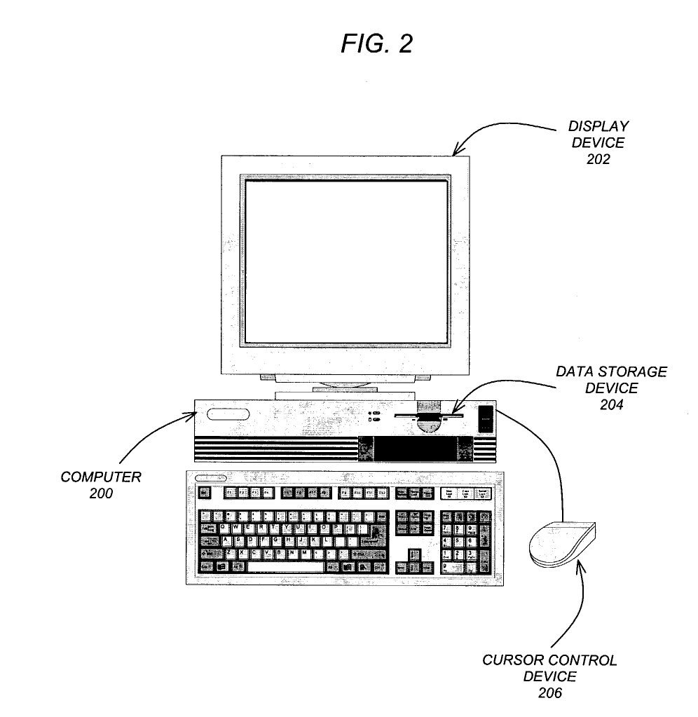

A typical displaying entity 108 comprises a modem 160 (and may also include a fiber receiver 158 or transceiver) for receiving and transmitting information through the back channel (i.e., via a communication path other than that provided by the satellite system described above) to and from the distribution entity 106. For example, feedback information (e.g. relating to system diagnostics, billing, usage and other administrative functions) from the exhibitor 108 can be transmitted through the back channel to the distribution entity 106. The output media content 128 and other information may be accepted into a processing system 164 (also referred to as a content server) such as a server or computer similar to that which is illustrated in FIG. 2 (see description below). The output media content 128 may then be stored in the storage device 166 for later transmission to displaying systems (e.g., digital projectors) 168A-168C. Before storage, the output media content 128 can be decrypted to remove transmission encryption (e.g. any encryption applied by the CAMS 132), leaving the encryption applied by the preparation processor 116.

When the media content 110 is to be displayed, final decryption techniques are used on the output media content 128 to substantially reproduce the original media content 110 in a viewable form which is provided to one or more of the displaying systems 168A-168C. For example, encryption 126 and compression 124 applied by the preparation processor 118 is finally removed, however, any latent modification, undetectable to viewers (e.g., watermarking 122) is left intact. In one or more embodiments, a display processor 170 prevents storage of the decrypted media content in any media, whether in the storage device 166 or otherwise. In addition, the media content 110 can be communicated to the displaying systems 168A-168C over an independently encrypted connection, such as on a gigabit LAN 172.

FIG. 2 is a functional block diagram of a computer system 200 that can be used to perform the operations of the media preparation processor 116 and processing system 164. Embodiments of the invention are typically implemented using a computer 200, which generally includes, inter alia, a display device 202, data storage devices 204, cursor control devices 206, and other devices. Those skilled in the art will recognize that any combination of the above components, or any number of different components, peripherals, and other devices, may be used with the computer 100.

Programs executing on the computer 100 (such as an operating system) are comprised of instructions which, when read and executed by the computer 200, causes the computer 200 to perform the steps necessary to implement and/or use the present invention. Computer programs and/or operating instructions may also be tangibly embodied in a memory and/or data communications devices of the computer, thereby making a computer program product or article of manufacture according to the invention. As such, the terms “article of manufacture,” “program storage device” and “computer program product” as used herein are intended to encompass a computer program accessible from any computer readable device or media.

2. Acquisition and Distribution of Behavioral Data

The novel system and method proposed herein will allow audience behavioral parameters to be sent to a central location from multiple sources, and accessed for use by industry decision makers and market analysts. The benefit of this is multi-pronged; the ubiquitous nature of the digital cinema architecture enables data to be collected from thousands of locations, and distributed to a central location with speed and accuracy. This greatly multiplies the data points used for diagnosing and predicting movie performance. It also provides instant feedback to the decisionmakers, which in effect allows them greater flexibility in updating production, distribution and marketing strategy.

For example, the effectiveness of advertising content can be accessed and assessed, trailers of unreleased movies can be tested in diverse locations to determine preferences and objections, already released movies can be tested with alternate endings, etc. Varied options then become available to decision makers in promoting, distributing, and producing content in a cinema venue.

Audience objection to themes, content quality and promotion methods are a direct indicator of performance or under performance of any content intended for mass consumption. For example, if only particular demographics express interest in a specific theme, distribution costs can be minimized in areas that expressed objections. If there is an overriding objection to a specific theme in a trailer of a movie in production, then a massive cost savings can be realized throughout the entire chain. If audiences suggest a lack of interest in an advertised product that was seen before the movie, the key message of that advertisement could be revised to yield better effectiveness.

Audiences can use a wireless input device such as a personal cell phone or other device to interface or fill out a questionnaire with general items related to their movie experience, based on different sets of information stimuli and post-movie evaluations. Data will then be collected from various information sources and transported via satellite, fiber or any other available means to a central location for storage and distribution to interested agents. For example, this may be performed through the network operation center of the digital cinema system previously detailed.

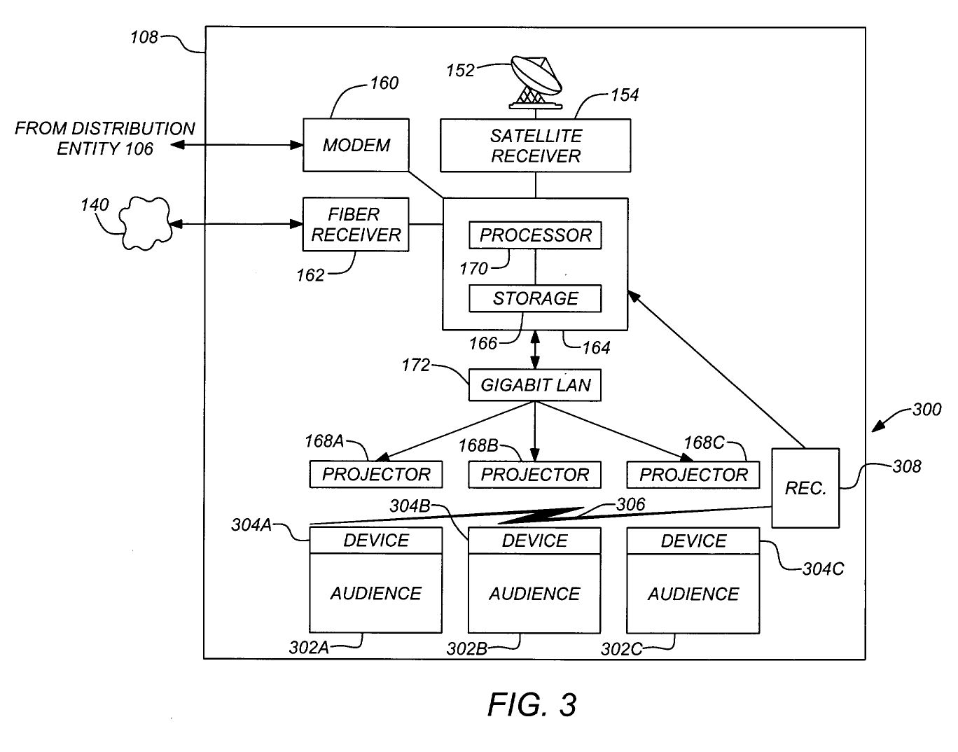

FIG. 3 is a block diagram of an exhibitor system of the present invention including the audience survey system 300. All the same elements exist as previously described respecting FIG. 1B, however, the audience survey system 300 includes one or more wireless devices 304A-304C (collectively referenced as 304) used by members of the audiences 302A-302C (collectively referenced as 302) of the cinema system. The wireless devices are used to allow the audience to provide feedback, e.g. responses to questions, regarding their cinema experience.

For example, a receiver 308 can be located at the exhibitor system. The wireless devices 304 transmit the responses to the survey questions to the receiver 308 over a wireless communication link 306. The wireless devices 304 can also be wireless network devices which establish two way connections with the receiver 308 (a transceiver in this case). Such wireless network devices can operate per the BLUETOOTH, IEEE 802.11 or other wireless network connectivity standards. For any such locally-connected wireless devices, the responses can be communicated to a processing system 164 of the exhibitor system 108, e.g. over direct connection or the gigabit LAN 172. In turn, the responses are communicated through the cinema system to a central source, e.g. over the modem 160 (via DSL Internet or PSTN) or fiber receiver 162, to a central source. The connection to the central source can alternately be implemented through the a separate dedicated modem or other link.

Importantly, the common infrastructure (including the operating software on the processing system 164) at each of the displaying entities 108 allows for standardized survey question presentation and data collection of the audience member responses. Furthermore, the responses can be communicated back to the central source over the same links used by the business operations system, e.g. the back channel. Alternately, separate communication links can be employed to handle the audience survey system responses. Currently other concepts are in use for other applications within the industry. Advantageously, implementation of the present invention for centralized distribution can be accomplished without major equipment modifications, particularly in the foregoing digital cinema environment.

For example, personal cell phones can be used as the device for inputing consumer responses. In this case, the survey responses are not collected and communicated from the displaying entities. Instead, the responses are transmitted from the individual cell phones directly to the central source (through the cell phone system). Communication with the individual audience members can be initially established by prompting the audience members (on the theater screen) with cell phones to first send a message or dial a number. Promotional incentives (e.g., discounted or free concession, etc.) can be used to encourage participation. In order to provide reasonable assurance that only the identified audience members are participating in the survey, a code (e.g., presented on the theater screen) can be required in order for responses to be accepted from the survey. The code can also be used to identify the question which is being answered; the code cross references the question at the central source. Furthermore, if promotional incentives are used, these can be “delivered” by communicating a coupon or gift code to the audience member which can be supplied by the audience member at the point of sale for redemption. The survey questions and/or responses can also be managed using a short messaging service (SMS) or other text messaging services which presently supplement many cellular phone services.

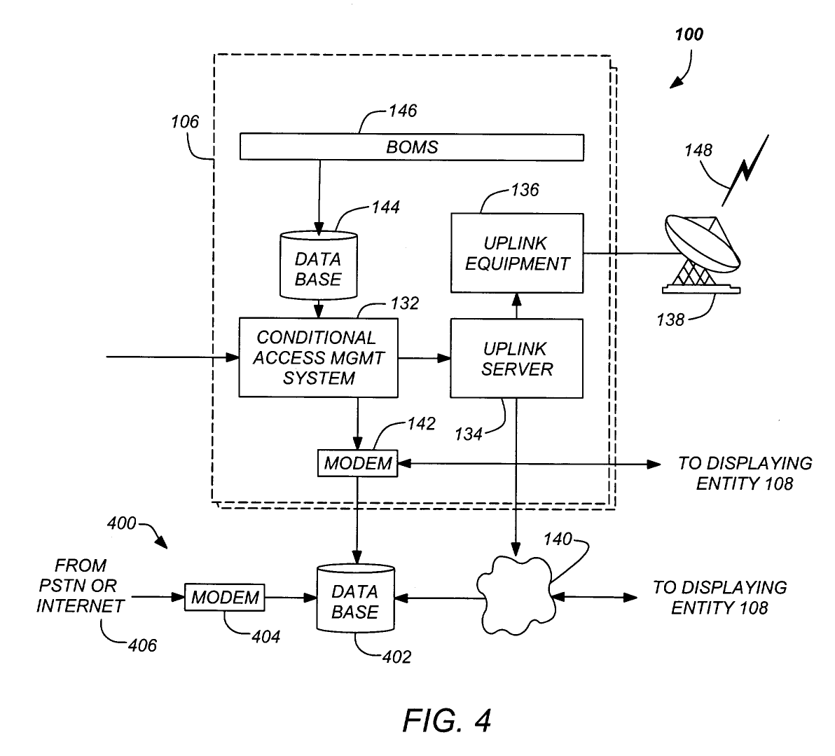

FIG. 4 is a block diagram of a central source 400 for accumulating the responses from the audience survey system 300. The central source 400 includes a database 402 where the responses are collected. As shown, the survey database 402 can be separate from the database 144 where output media content 128 is stored under the control and management of the business operations management system (BOMS) 146. In other embodiments, the survey database 402 can be integrated into the database 144 and BOMS 146. Thus, the survey responses can be received at the database 402 through a various possible communication links. For example, as previously mentioned, the back channel of the cinema system can be used, e.g. through the modem 142 or the fiber network 140. Alternately, the responses can be received through a dedicated modem 404 communicated over a public switched telephone network (PSTN) or Internet link 406.

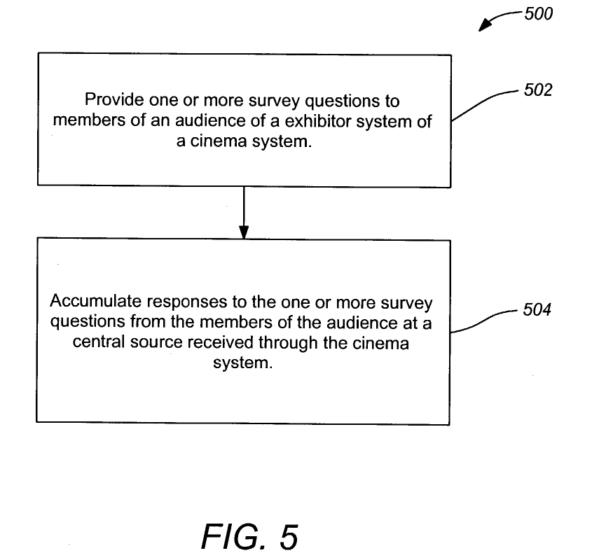

FIG. 5 is a flowchart of a typical method 500 for acquiring behavioral data for content evaluation of the present invention. At step 502, one or more survey questions are provided to members of an audience of a exhibitor system of a cinema system. Next at step 504, the responses to the one or more survey questions from the members of the audience are accumulated at a central database received through the cinema system. The basic method 500 can be modified to incorporate various elements of the system previously described in FIGS. 1A-4.

Using the forgoing architecture, many formats are possible for the presentation of questions and the receiving of responses. For example in a typical embodiment, survey questions can be provided directly to the audience members on the cinema screen. Audience members can submit their responses with their own cell phones or PDA devices using a given code as previously mentioned. In this case, the questions are provided at the beginning and/or end of the movie, communicated from the database 144 and merged into the overall presentation from the distribution entity 106. In another format, the questions can be provided to the audience through their cell phones or PDA devices after the audience is prompted (on screen) to provide contact information through their devices. Providing questions in this manner allows for the surveying to take place at another time, e.g. hours or even days later.

After the survey responses are accumulated at the central source 400, the raw results can be made available to marketing and content producing personnel. For example, authorized entities can log into the database 402 at the central source 400 and download the responses for analysis.

Embodiments of the invention are at the forefront of the packaging and transport of digital media. The invention can provide accurate and essential analysis data for decision-makers on a widespread level. This can increase revenues for digital cinema and the entire industry, representing an untapped market with great promise.

According to the Motion Picture Association of America (MPAA), the cost of launching a new movie in the U.S. is $82 million approximately $52 million for production costs and $30 million for marketing and distribution. As of 2000 box office sales were in excess of $7.7 billion. Considering the fact that approximately 60% of all movies released today under perform, a centralized electronic/digital mechanism for capturing and distributing factors that impact audience acceptance presents massive improvements of the current methods and revenue bearing opportunities to the industry.

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A method for acquiring behavioral data for content evaluation, comprising:
providing one or more survey questions to members of an audience of a exhibitor system of a cinema system; and
accumulating responses to the one or more survey questions from the members of the audience at a central database received through the cinema system.

2. The method of claim 1, wherein the received responses are communicated to the central database through a back channel from the exhibitor system.

3. The method of claim 1, wherein the one or more questions are provided on a display to the audience of the exhibitor system.

4. The method of claim 1, wherein the one or more questions relate to a movie or advertisement viewed by the audience on the exhibitor system.

5. The method of claim 1, wherein the responses received through at least one wireless device.

6. The method of claim 5, wherein the wireless device comprises a cellular phone or a personal digital assistant (PDA).

7. The method of claim 5, wherein the wireless device comprises a wireless network device.

8. The method of claim 5, wherein the one or more questions are provided to the members of the audience on the wireless device.

9. The method of claim 5, wherein the wireless device provides the one or more survey questions through a short messaging service.

10. The method of claim 5, wherein a receiver disposed at the exhibitor system receives the responses to the one or more survey questions from the at least one wireless device and communicates them through the exhibitor system to the central database.

11. The method of claim 5, wherein the central database receives the responses to the one or more survey questions directly from the at least one wireless device.

12. The method of claim 5, wherein the wireless device communicates the responses to the one or more survey questions directly from the at least one wireless device through a short messaging service.

13. A system for acquiring behavioral data for content evaluation, comprising:
a device for providing one or more survey questions to members of an audience of a exhibitor system of a cinema system; and
a central database for accumulating responses to the one or more survey questions from the members of the audience received through the cinema system.

14. The system of claim 13, wherein the received responses are communicated to the central database through a back channel from the exhibitor system.

15. The system of claim 13, wherein the one or more questions are provided on a display to the audience of the exhibitor system.

16. The system of claim 13, wherein the one or more questions relate to a movie or advertisement viewed by the audience on the exhibitor system.

17. The system of claim 13, wherein the responses received through at least one wireless device.

18. The system of claim 17, wherein the wireless device comprises a cellular phone or a personal digital assistant (PDA).

19. The system of claim 17, wherein the wireless device comprises a wireless network device.

20. The system of claim 17, wherein the one or more questions are provided to the members of the audience on the wireless device.

21. The system of claim 17, wherein the wireless device provides the one or more survey questions through a short messaging service.

22. The system of claim 17, wherein a receiver disposed at the exhibitor system receives the responses to the one or more survey questions from the at least one wireless device and communicates them through the exhibitor system to the central database.

23. The system of claim 17, wherein the central database receives the responses to the one or more survey questions directly from the at least one wireless device.

24. The system of claim 17, wherein the wireless device communicates the responses to the one or more survey questions directly from the at least one wireless device through a short messaging service.
